(19) United States
(12) Patent Application Publication
(10) Pub. No.: US 2010/0025955 A1
(43) Pub. Date: Feb. 4, 2010

(54) FOLDABLE TRUCK STAIRS

(76) Inventor: Robert C. Carr, JR., Manchester, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 12/512,087

(22) Filed: Jul. 30, 2009

Related U.S. Application Data
(60) Provisional application No. 61/085,105, filed on Jul. 31, 2008.

(51) Int. Cl. B60R 3/00

(52) U.S. Cl. 280/166

(57) ABSTRACT

A foldable stair assembly for a vehicle which is carried by a trailer hitch receiver in the vehicle and wherein the stairs include independently retractable stair riser extender portions which serve to contact the ground to stabilize the stairs against the ground, and wherein the retractable stair portions can adjust for uneven or sloping ground. A piston or other assistance member aids in raising and lowering the stairs.

### CROSS-REFERENCE TO RELATED APPLICATION

The present application claims priority from U.S. provisional patent application No. 61/085,105 filed Jul. 31, 2008 entitled “Foldable Truck Step” incorporated fully herein by reference.

### TECHNICAL FIELD

The present invention relates to truck stairs and more particularly, relates to foldable truck stairs which are held in place in a trailer hitch receiver for accessing the back of pickup trucks, trailers and other vehicles.

### BACKGROUND INFORMATION

The cargo bed and/or rear of a pickup truck, camper or other similar vehicle is often difficult to access because these areas are generally from 2 to 3 feet off the ground. One often has to climb on a bumper or on one's knees to access these areas. In addition, without the use of plaintiffs or other similar device, it is difficult if not impossible to bring merchandise into these cargo areas using a two wheeled dolly.

Although numerous step type devices including step ladders and steps that fit into the receiver hitch of a trailer have been developed, they all suffer from one or more shortcomings. In some of these devices, while in others, it does not extend all the way to the ground.

Accordingly, what is needed is a set of foldable stairs which are held in place by inserting a first tubular member into a corresponding trailer hitch receiver fastened to the vehicle, and which stairs fold flat against the vehicle and have two extendable legs which can independently extend and retract to make contact with the ground when the stairs are in an unfolded position.

### SUMMARY

The present invention features a foldable stepping device for use in conjunction with a trailer hitch receiver. The foldable stepping device includes an extension member, configured for insertion into a trailer hitch receiver, and a foldable stair assembly, coupled to the extension member, and configured for being moved between a first stored position and a second deployed position.

The foldable stair assembly comprises a first extendable riser member and a second extendable riser member, each of the first and second riser members including a first end and a second end. A plurality of stairs, each having a first end and a second end, are interconnected with the first extendable riser member. Also included are a first extendable riser extender, coupled to and extendable from the second end of the first extendable riser member, and a second extendable riser extender, coupled to and extendable from the second end of the second extendable riser member. Each of the first and second extendable riser extenders are configured for being independently extendable from their respective extendable riser members.

The device may, in one embodiment, further comprise a folding mechanism, coupled to the first and second extendable riser members, wherein the folding mechanism allows the foldable stair assembly to be rotated from the first, stored position, to the second deployed position, and from the second deployed position to the first stored position. The device may also include at least one piston, coupled between the extension member and the foldable stair assembly, wherein the piston is configured to aid a user in both moving the foldable stair assembly from the first stored position to the second deployed position and moving the foldable stair assembly from the second deployed position to the first stored position.

In the preferred embodiment, the foldable stair assembly is produced from a material that is lightweight and non-corrosive such as aluminum, stainless steel, and carbon. Further, the plurality of stairs may be provided with holes, perforations, or a roughened surface to increase traction and prevent slipping.

The foldable stair assembly may further include a first handle device coupled to the first extendable riser member and a second handle device coupled to the second extendable riser member, wherein the first handle device and second handle device are configured for allowing a user to grasp at least one of the first handle device and the second handle device to move the foldable chair assembly from the first stored position to the second deployed position or from the second deployed position to the first stored position. A retractable pin may be provided which is configured for engagement with one of a plurality of holes in each of said first and second extendable riser extender, and configured for holding said first and second extendable riser extender in a fixed position.

### BRIEF DESCRIPTION OF THE DRAWINGS

These and other features and advantages of the present invention will be better understood by reading the following detailed description, taken together with the drawings wherein:

FIG. 1 is a perspective view of the foldable stairs according to the present invention in place on a vehicle in the folded downward position;

FIG. 2 is a perspective view of the foldable stairs in place on a vehicle in the folded upward position;

FIGS. 3A and 3B are a close-up view of the foldable stairs of the present invention illustrating the riser extenders according to the present invention; and

FIG. 4 is a detailed view of the foldable mechanism according to the present invention.

### DETAILED DESCRIPTION OF THE PREFERRED EMBODIMENTS

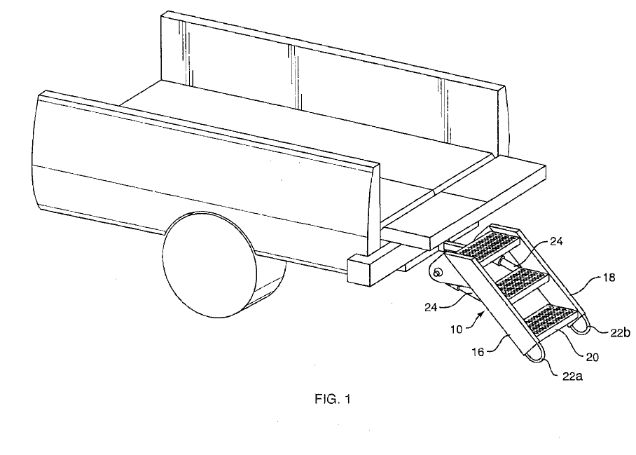

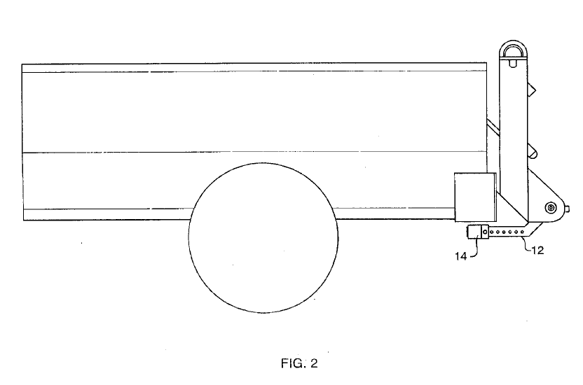

The present invention features a foldable step 10, FIG. 1, which has an extension member 12, FIG. 2, which is inserted into a trailer hitch receiver member 14 typically found on pickup trucks, cars, campers, trailers and the like. The extension member is typically of a squared tubular shape or other shape that is compatible with the trailer hitch receiver member.

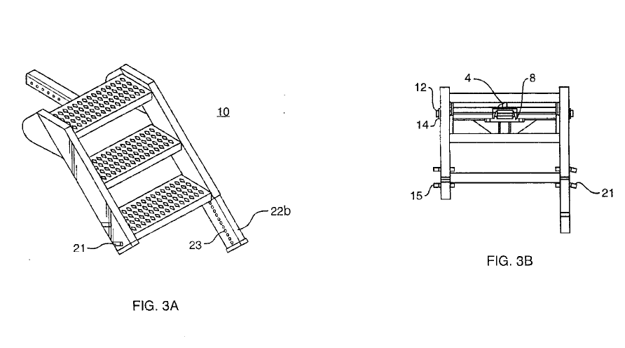

The foldable stairs include a first riser member 16 and a second riser member 18 between which are connected a plurality of steps 20. One feature of the present invention is the provision of extendable step regions 22 at the bottom of each riser member 16, 18. The extendable step regions 22 can be releasably and independently extended, FIG. 3A, to allow the step 10 to firmly and securely rest on the ground to support the weight on the step. The extendable step regions 22 can include an end portion that is rounded (as shown in FIG. 1) or more square (as shown in FIG. 3A) as well as any other appropriate shape desired. The foldable stairs may also include a retractable pin 21, which may be spring loaded, and which mates with one or more holes 23 in the extendable steps 22 to allow the extendable step to be adjustable to the desired position, and retracted and held in place.

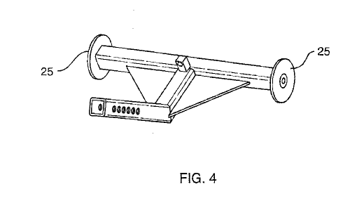

The stairs are coupled to a folding mechanism FIG. 4, which includes rotatable end plates 25 to which the riser members 16, 18 are attached, and which allow the stairs to be folded from a deployed position (FIG. 1) to a stored position (FIG. 2). In addition, one or more pistons 24, FIG. 1 or other similar mechanism may be provided to aid the user in either or both lifting the stairs to the stored position or lowering the stairs to the deployed position. The piston makes it easier to raise and lower the stair assembly by reducing the amount of weight the user has to handle, by allowing some of the weight to be transferred to and attended by the piston.

In the preferred embodiment, the stairs can be made of relatively lightweight, non-corrosive material such as aluminum although other materials such as stainless steel, carbon composite or other composites and the like are contemplated and within the scope of the present invention. The stairs 20 may have holes, perforations or other roughened surface to prevent a user from slipping while using them.

An additional feature of the present invention is the ability to use the stair assembly in connection with a trailer hitch and a two-wheeled dolly, which is designed to negotiate home or apartment stairways. Using the present invention, a two-wheeled moving dolly loaded with boxes, an appliance or the like may be pulled up the stairs into the bed of the pickup truck or moved from the bed of the pickup truck to the ground without the need for additional ramps and the like. The two-wheeled dolly will have one wheel that is in contact with the first riser member and a second wheel that is in contact with the second riser member. The first and second wheels of the two-wheeled dolly will be lined up with the ramp that is formed by the first and second riser members and used as a ramp to maneuver the two-wheeled dolly up or down the upper face of the first and second riser members.

Accordingly, the present invention provides a novel, foldable stair for a vehicle that is carried by a trailer hitch receiver in the vehicle and wherein the stairs include independently retractable stair portions that may contact with the ground to stabilize the stairs against the ground, and wherein the retractable stair portions can adjust for uneven or sloping ground.

The present invention is not intended to be limited to a device or method which must satisfy one or more of any stated or implied objects or features of the invention and should not be limited to the preferred, exemplary, or primary embodiment(s) described herein. Modifications and substitutions by one of ordinary skill in the art are considered to be within the scope of the present invention, which is not to be limited except by the allowed claims and their legal equivalents.

The invention claimed is:

1. A foldable stepping device for use in conjunction with a trailer hitch receiver, comprising:
an extension member, configured for insertion into a trailer hitch receiver;
a foldable stair assembly, coupled to the extension member, and configured for being moved between a first stored position and a second deployed position, the foldable stair assembly comprising:
a first extendable riser member and a second extendable riser member, each of the first and second riser members including a first end and a second end;
a plurality of steps, each of the plurality of steps having a first end and a second end, wherein the first end of each of the plurality of steps is interconnected with the first extendable riser member and the second end of each of the plurality of steps is interconnected with the second extendable riser member; and
a first extendable riser extender, coupled to and extendable from the second end of the first extendable riser member, and a second extendable riser extender, coupled to and extendable from the second end of the second extendable riser member, each of the first and second extendable riser extenders configured for being independently extendable from their respective extendable riser members.

2. The device of claim 1, further comprising:
a folding mechanism, coupled to the first and second extendable riser members, wherein the folding mechanism allows the foldable stair assembly to be rotated from the first, stored position, to the second deployed position, and from the second deployed position to the first stored position.

3. The device of claim 2, further comprising:
at least one piston, coupled between the extension member and the foldable stair assembly, wherein the piston is configured to aid a user in both moving the foldable stair assembly from the first stored position to the second deployed position and moving the foldable stair assembly from the second deployed position to the first stored position.

4. The device of claim 1, wherein the foldable stair assembly is produced from a material that is lightweight and non-corrosive.

5. The device of claim 4, wherein the material is selected from the group consisting of aluminum, stainless steel, and carbon.

6. The device of claim 1, wherein the plurality of stairs are provided with holes, perforations, or a roughened surface.

7. The device of claim 1, wherein the foldable stair assembly further comprises:
a first handle device coupled to the first extendable riser member and a second handle device coupled to the second extendable riser member, wherein the first handle device and second handle device are configured for allowing a user to grasp at least one of the first handle device and the second handle device to move the foldable chair assembly from the first stored position to the second deployed position or from the second deployed position to the first stored position.

8. The device of claim 1, wherein the foldable stair assembly further comprises a retractable pin, configured for engagement with one of a plurality of holes in each of said first and second extendable riser extender, and configured for holding said first and second extendable riser extender in a fixed position.
